(19) United States
(12) Patent Application Publication
(10) Pub. No.: US 2006/0197263 A1
(43) Pub. Date: Sep. 7, 2006

(54) Blow air control system

(75) Inventors: Matthew Crider, Red Lion, PA (US); Michael J. Kelly, Red Lion, PA (US)

Correspondence Address: VENABLE LLP, P.O. BOX 34385, WASHINGTON, DC, 20045-9998, US

(73) Assignee: Graham Packaging Company, L.P., York, PA (US)

(21) Appl. No.: 11/363,489

(22) Filed: Feb. 28, 2006

Related U.S. Application Data
(60) Provisional application No. 60/657,730, filed on Mar. 3, 2005.

(51) Int. Cl. B29C 49/00

(52) U.S. Cl. 264/529; 425/535

(57) ABSTRACT

Blow air control systems control injecting a first gas at a first pressure into the interior of a parison and then injecting a second gas at a second pressure greater than the first pressure into the interior of the parison in blow-molding a container.

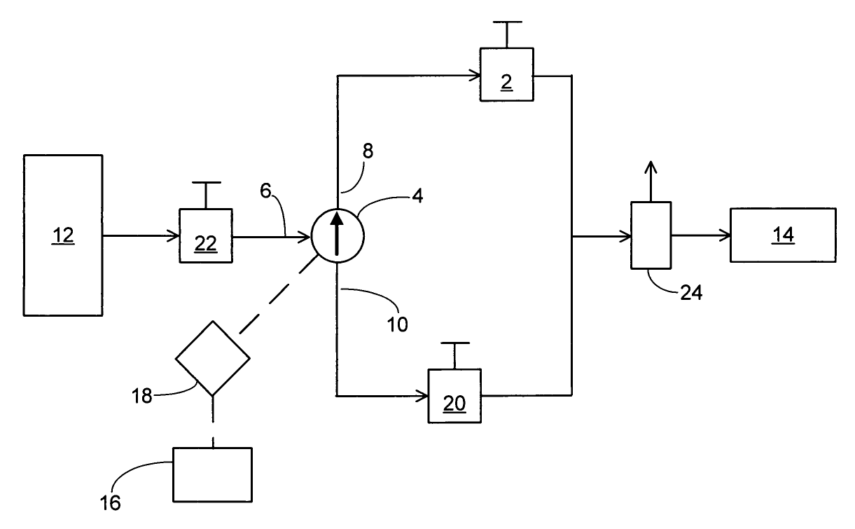

### FIELD OF THE INVENTION

The present invention relates to a blow air control system, which can be used as a component of a blow molding system. More particularly, the invention is a network including a valve and a regulator for injecting air at a low pressure into a parison and for injecting air at a high pressure into a parison.

### DESCRIPTION OF THE RELATED ART

Blow molding systems can inflate a parison by pushing an injection nozzle into the parison and injecting air through the nozzle into the interior of the parison. The parison can be inflated so that the exterior surface of the parison presses against a mold, and the parison assumes the shape of the mold. Pressing the parison exterior surface against the mold can also facilitate cooling of the parison through conduction of heat from the parison through the mold. It can be useful to use a high pressure to inflate the parison, so that the parison exterior surface presses firmly against the mold and assumes the shape of fine features, i.e., features of small size, of the mold, so that the resultant product, for example, a container, has these fine features. It is thought that pressing the parison exterior surface firmly against the mold can also improve the rate of cooling and the uniformity of temperature through the parison.

However, use of a high pressure to inflate the parison can lead to blow out during inflation. Blow out can result, for example, from the stream of air emitted from the nozzle puncturing the parison opposite of where the injection nozzle penetrated the parison. It is thought that when blow out occurs, the lower differential of pressure within and outside of the parison can result in the parison exterior surface being pressed less firmly against the mold so that the product does not have fine features of the mold and has a poor quality finish. When blow out occurs, the product may also have an opening in the region of the blow out, which can cause it to leak when filled with, for example, a gas, a liquid, or a finely divided solid.

In order to maximize the economic return from equipment, it is desirable to run equipment at the highest rate of output possible. When blow molding equipment is run at a higher rate of output, the temperature of a parison in the mold can be higher. It is thought that the higher temperature of the parison can result in the parison having lower strength so that blow out can occur with greater frequency than if blow molding equipment were run at a lower rate of output.

Developing and manufacturing molds which contain interstices through which low temperature fluid can flow to cool the parison would be expensive and lead to increased capital cost of blow molding equipment. Furthermore, such a cooled mold may not be effective at cooling the parison before and while it is being inflated and before the exterior surface of the parison contacts the mold.

Developing and manufacturing new molds in which the mold dimensions are changed so that the mold is suitable for operation with blow molding equipment operating at a high production rate would be expensive.

There thus remains an unmet need for a blow air control system that allows blow molding equipment to be run at high speed without parison blow out, allows products having fine features of a mold and a high quality finish to be produced, and does not require expensive modification or replacement of molds.

### SUMMARY OF THE INVENTION

It is therefore an object of the present invention to provide novel blow air control systems for blow molding a container from a parison that allow blow molding equipment to be run at high speed without parison blow out, allow products having fine features of a mold and a high quality finish to be produced, and do not require expensive modification or replacement of molds.

An embodiment of a blow air control system of the present invention includes a low pressure regulator and a three-way valve having a common port, a low pressure port, and a high pressure port. The common port can be for fluidly coupling to a gas supply, the high pressure port can be for fluidly coupling to an injection nozzle, and the low pressure port can be fluidly coupled to the low pressure regulator. The low pressure regulator can be for fluidly coupling to the injection nozzle. The low pressure regulator can include a self-relieving regulator. The blow air control system according to the present invention can include a quick exhaust valve fluidly coupled to the low pressure regulator and to the high pressure port, and for fluidly coupling to the injection nozzle.

A blow air control system of the present invention can include a timer for controlling shunting the three-way valve to fluidly couple the low pressure port to the common port for a first predetermined period of time. An actuator can be coupled to the three-way valve. A timer can be coupled to the actuator for controlling shunting the three-way valve to fluidly couple the low pressure port to the common port for a first predetermined period of time. The timer can be electrically coupled to the actuator, mechanically coupled to the actuator, or pneumatically coupled to the actuator. A computer system can be electrically coupled to the actuator for controlling shunting the three-way valve to fluidly couple the low pressure port to the common port for a first predetermined period of time.

An embodiment of a blow air control system of the present invention includes a high pressure regulator, fluidly coupled to the high pressure port and for fluidly coupling to the injection nozzle. A quick exhaust valve can be fluidly coupled to the low pressure regulator and the high pressure regulator and can be for fluidly coupling to the injection nozzle. A supply gas regulator can be fluidly coupled to the common port of the three-way valve and can be for fluidly coupling to the gas supply.

In a method for blow molding a container from a parison, a parison having a parison interior is provided. A first gas can be firstly injected at a first pressure into the parison interior. A second gas can be secondly injected at a second pressure into the parison interior to form the container; the second pressure can be greater than the first pressure. The first gas can be injected at the first pressure for a first predetermined period of time; the first predetermined period of time can be, for example, in a range of from about 0.1 seconds to about 3 seconds. The second gas can be injected at the second pressure for a second predetermined period of time. The first pressure can be, for example, in a range of from about 18 psi to about 60 psi. The second pressure can be, for example, in a range of from about 85 psi to about 140 psi; the second pressure can be as great as a supply gas pressure. The first gas and the second gas can be, for example, air.

The injection of the first gas and the injection of the second gas can be controlled by shunting a three-way valve; an actuator can shunt the three-way valve. The shunting by the actuator can be controlled by a timer: the shunting by the actuator can be electrically, mechanically, or pneumatically controlled by the timer.

### BRIEF DESCRIPTION OF THE DRAWING

The FIGURE is a schematic of an embodiment of a blow air control system according to the present invention.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without parting from the spirit and scope of the invention. All references cited herein are incorporated by reference as if each had been individually incorporated.

In an embodiment of a blow air control system according to the present invention, shown in the FIGURE, a three-way valve 4 can control whether high pressure gas flows into an injection nozzle 14 or whether low pressure gas flows into the injection nozzle 14. A three-way valve 4 includes valves having a common port 6 and two or more selectable ports in which any one of the selectable ports can be fluidly coupled to the common port 6. The three-way valve 4 can include a common port 6, a low pressure port 8, and a high pressure port 10. The common port 6 can be fluidly coupled to a gas supply 12. The high pressure port 10 can be fluidly coupled to the injection nozzle 14. The low pressure port 8 can be fluidly coupled to a low pressure regulator 2, and the low pressure regulator 2 can be fluidly coupled to the injection nozzle 14. The three-way valve 4 can be shunted to fluidly couple the common port 6 and the high pressure port 10; the three-way valve 4 can also be shunted to fluidly couple the common port 6 and the low pressure port 8. The low pressure regulator 2 can include a self-relieving regulator.

The blow air control system according to the present invention can include a quick exhaust valve 24. The low pressure regulator 2 and the high pressure port 10 can be fluidly coupled to the quick exhaust valve 24. The quick exhaust valve 24 can be fluidly coupled to the injection nozzle 14. The quick exhaust valve 24 can be, for example, fluidly coupled and capable of venting to an environment or a storage tank. The quick exhaust valve 24 can include a check valve. The check valve can allow gas to flow from the blow air control system to the injection nozzle 14, but can prevent gas from flowing from the injection nozzle 14 back into the blow air control system. For example, the check valve can allow gas to flow from the low pressure regulator 2 into the injection nozzle 14, and can allow gas to flow from the high pressure port 10 into the injection nozzle 14; however, the check valve can prevent gas from flowing from the injection nozzle 14 to the low pressure regulator 2 or to the high pressure port 10.

The blow air control system can include a timer 16 for controlling the shunting of the three-way valve 4. When triggered, the timer 16 can control the shunting of the three-way valve 4 to fluidly couple the low pressure port 8 to the common port 6 for a first predetermined period of time, such that gas at low pressure is injected through the injection nozzle 14 into the parison for the first predetermined period of time. Once the first predetermined period of time has elapsed, the timer 16 can control the shunting of the three-way valve 4 to fluidly couple the high pressure port 10 to the common port 6, such that gas at high pressure is injected through the injection nozzle 14.

The timer 16 can indicate through a display that the three-way valve 4 is to be manually shunted to fluidly couple the low pressure port 8 to the common port 6 for the first predetermined period of time. The timer 16 can indicate through the display that the first predetermined period has elapsed, so that the three-way valve 4 is to be manually shunted to fluidly couple the high pressure port 10 to the common port 6.

Alternatively, an actuator 18 can be coupled to the three-way valve 4. The actuator 18 can have, for example, the form of a solenoid mechanically coupled to the three-way valve 4. The timer 16 can be coupled to the actuator 18, such that the timer 16 can, through the actuator 18, control shunting of the three-way valve 4, for example, shunting of the three-way valve 4 to fluidly couple the low pressure port 8 to the common port 6 for a first predetermined period of time. The timer 16 can be, for example, electrically coupled to the actuator 18. For example, the timer 16 can send an electrical signal or an electrical current to an actuator 18 including a solenoid, so that the actuator 18 shunts, that is, changes the position of, the three-way valve 4. The timer 16 can be, for example, mechanically coupled to the actuator 18. For example, the timer 16 can include a cam that can trigger or cause motion of the actuator 18 to shunt the three-way valve 4. The timer 16 can be, for example, pneumatically coupled to the actuator 18. For example, the actuator 18 can include a piston mechanically coupled to the three-way valve 4. The timer 16 can send an air pressure signal or pressurized air to the actuator 18, so that the actuator 18 shunts the three-way valve 4. The timer 16 can be, for example, realized as one or more cams on a blow molding wheel. When a blow molding wheel moves into the position where high pressure air is to be injected into the parison, a cam can cause the shunting of the three-way valve 4 from a low pressure position, where the low pressure port 8 is fluidly coupled to the common port 6, to a high pressure position, where the high pressure port 10 is fluidly coupled to the common port 6. For example, a raised cam can advance to trigger an electrical switch. The electrical switch can trigger an actuator 18 including a solenoid which shunts the three-way valve 4. The cam can trigger a pneumatic valve which allows pilot air to flow to an actuator 18 which includes a piston which shunts the three-way valve 4. The cam can trigger a lever which mechanically shunts the three-way valve 4. For example, the absence of the cam, i.e., the advancement of the cam beyond the point where the cam triggers, e.g., an electrical switch, a pneumatic valve, or a lever, or the advancement of a different cam to the point where the cam triggers can cause the three-way valve 4 to shunt from the high pressure position to the low pressure position. The extent of a single cam or the distance between a cam that causes the three-way valve 4 to shunt to the high pressure position and a cam that causes the three-way valve 4 to shunt to the low pressure position can be adjusted to control the duration of the first predetermined period of time.

A computer system can be coupled to the actuator 18, either directly or through a timer 16, for controlling shunting of the three-way valve 4, for example, shunting of the three-way valve 4 to fluidly couple the low pressure port 8 to the common port 6 for a first predetermined period of time. The computer system can be, for example, electrically coupled to the actuator 18.

The blow air control system can include a high pressure regulator 20, fluidly coupled to the high pressure port 10 of the three-way valve 4 and fluidly coupled to the injection nozzle 14. A quick exhaust valve 24 can be fluidly coupled to the low pressure regulator 2 and to the high pressure regulator 20, and can be fluidly coupled to the injection nozzle 14. A supply gas regulator 22 can be fluidly coupled to the common port 6 of the three-way valve 4 and to the gas supply 12.

In a method for blow molding a container from the parison according to the present invention, a parison having a parison interior can be provided. A first gas at a first pressure can be injected into the parison interior; then, a second gas at a second pressure can be injected into the parison interior to form the container. The second pressure can be greater than the first pressure. The first gas at a lesser pressure can inflate the parison gently against the mold wall; through contact with a cool mold, the parison can cool before the second gas at a greater pressure is injected into the mold. The first gas and/or the second gas can be cooler than the parison. The injection of the first gas at a lower pressure can allow the parison to conform to mold features having small radii during the molding process. The injection of a first gas at a lesser pressure to initially inflate the parison can help to prevent blow out of the parison during the molding process. The injection of a second gas at a greater pressure can act to press the parison exterior surface firmly against the mold, so that the parison exterior surface can assume the shape of fine features of the mold, and so that the parison can cool rapidly and the temperature throughout the parison can be substantially uniform.

The first gas can be injected at the first pressure for a first predetermined period of time; this first predetermined period of time can be, for example, in a range of from about 0.1 seconds to about 3 seconds. The first pressure can be, for example, in a range of from about 18 psi to about 60 psi, and the second pressure can be, for example, in a range of from about 85 psi to about 140 psi. It can be advantageous to make the second pressure as great as possible, so that the parison is pressed as forcefully against the wall of the mold as possible. By pressing the parison firmly against the mold wall, heat can rapidly flow from the parison into the mold wall, allowing the production rate of the container molding apparatus to be increased. The second pressure can be as great as the pressure of the gas supply available, and can be greater than 140 psi.

For example, in molding a bottle with an interior volume of one liter, the first predetermined period of time can be about 0.2 seconds, the first pressure can be about 35 psi, and the second pressure can be about 95 psi. In molding a bottle with an interior volume of one gallon or more, the first predetermined period of time can be about 0.5 seconds, the first pressure can be about 60 psi, and the second pressure can be about 95 psi.

The first gas and the second gas may be the same or different. The first gas can be, for example, air, another gas, or a mixture of gases; the second gas can be air, another gas, or a mixture of gases.

The injection of the first gas and the injection of the second gas can be controlled by shunting a three-way valve 4. The three-way valve 4 can be manually shunted or an actuator 18 can shunt the three-way valve 4. Shunting by an actuator 18 can be controlled by a timer 16. For example, shunting by the actuator 18 can be electrically, mechanically, or pneumatically controlled by the timer 16.

In a method for blow molding a container from a parison, the second gas can be injected at the second pressure for a second predetermined period of time. The quick exhaust valve 24 can be, for example, actuated to vent gas from the blow air control system to an environment or a storage tank after the second gas has been injected into the parison at the second pressure, for example, for the second predetermined period of time.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A blow air control system for controlling pressure of a gas supplied to an injection nozzle for blow molding a container from a parison, comprising:
a low pressure regulator; and
a three-way valve, comprising a common port, a low pressure port, and a high pressure port,
the common port for fluidly coupling to a gas supply,
the high pressure port for fluidly coupling to the injection nozzle,
the low pressure port fluidly coupled to the low pressure regulator, and
the low pressure regulator for fluidly coupling to the injection nozzle.

2. The system of claim 1, further comprising a quick exhaust valve.

3. The system of claim 2, the quick exhaust valve fluidly coupled to the low pressure regulator and the high pressure port and for fluidly coupling to the injection nozzle.

4. The system of claim 1, wherein the low pressure regulator comprises a self-relieving regulator.

5. The system of claim 1, further comprising a timer for controlling shunting the three-way valve to fluidly couple the low pressure port to the common port for a first predetermined period of time.

6. The system of claim 1, further comprising an actuator coupled to the three-way valve.

7. The system of claim 6, further comprising a timer coupled to the actuator for controlling shunting the three-way valve to fluidly couple the low pressure port to the common port for a first predetermined period of time.

8. The system of claim 7, wherein the timer is electrically coupled to the actuator.

9. The system of claim 7, wherein the timer is mechanically coupled to the actuator.

10. The system of claim 7, wherein the timer is pneumatically coupled to the actuator.

11. The system of claim 6, further comprising a computer system electrically coupled to the actuator for controlling shunting the three-way valve to fluidly couple the low pressure port to the common port for a first predetermined period of time.

12. The system of claim 1, further comprising a high pressure regulator, fluidly coupled to the high pressure port and for fluidly coupling to the injection nozzle.

13. The system of claim 12, further comprising a quick exhaust valve fluidly coupled to the low pressure regulator and the high pressure regulator and for fluidly coupling to the injection nozzle.

14. The system of claim 1, further comprising a supply gas regulator, fluidly coupled to the common port of the three-way valve and for fluidly coupling to the gas supply.

15. A method for blow-molding a container from a parison, comprising:
providing a parison having a parison interior;
firstly injecting a first gas at a first pressure into the parison interior; and
secondly injecting a second gas at a second pressure into the parison interior to form the container,
wherein the second pressure is greater than the first pressure.

16. The method of claim 15, wherein the injecting of the first gas and the injecting of the second gas are controlled by shunting a three-way valve.

17. The method of claim 16, wherein the shunting is by an actuator.

18. The method of claim 17, wherein the shunting by the actuator of the three-way valve is controlled by a timer.

19. The method of claim 18, wherein the shunting by the actuator is electrically controlled by the timer.

20. The method of claim 18, wherein the shunting by the actuator is mechanically controlled by the timer.

21. The method of claim 18, wherein the shunting by the actuator is pneumatically controlled by the timer.

22. The method of claim 15, wherein the first gas is injected at the first pressure for a first predetermined period of time.

23. The method of claim 22, wherein the first predetermined period of time is in a range of from about 0.1 seconds to about 3 seconds.

24. The method of claim 15,
wherein the first pressure is in a range of from about 18 psi to about 60 psi, and
wherein the second pressure is in a range of from about 85 psi to about 140 psi.

25. The method of claim 15, wherein the second pressure can be as great as a supply gas pressure.

26. The method of claim 15, wherein the second gas is injected at the second pressure for a second predetermined period of time.

27. The method of claim 15, wherein the first gas and the second gas are air.
